(19) United States
(12) Patent Application Publication
(10) Pub. No.: US 2005/0182680 A1
(43) Pub. Date: Aug. 18, 2005

(54) Wireless point-of-sale system and method for management of restaurants

(76) Inventors: Melvin Jones III, Wynnewood, PA (US); Gaurav Palvia, Pune (IN)

Correspondence Address: WILLIAM H. EILBERG, THREE BALA PLAZA, SUITE 501 WEST, BALA CYNWYD, PA, 19004, US

(21) Appl. No.: 10/779,803

(22) Filed: Feb. 17, 2004

(51) Int. Cl. G06F 17/60

(52) U.S. Cl. 705/15

(57) ABSTRACT

An automated system for management of a restaurant or bar includes a server computer, several wireless hand-held units, and at least one stationary touchscreen unit. A master copy of a menu is stored in the server, and changes to the master copy are automatically made to local copies stored in the hand-held and touchscreen units. Thus, all copies of the menu, in all of the units, are quickly and automatically synchronized. The system allows a manager to indicate the quantity remaining of a particular item, and that quantity is updated, in all of the hand-held and touchscreen units, as orders for that item are placed. When the quantity remaining of the item reaches zero, the system rejects further orders for the item. The system allows a waiter to print an order or a bill from any one of a variety of selected printers. The system therefore greatly enhances the efficiency of operation of the restaurant or bar.

### BACKGROUND OF THE INVENTION

The present invention relates to the field of operation and management of restaurants and/or bars, and provides a computerized system and method that makes such operation more efficient.

Computer-based ordering systems have been known in the restaurant industry. For example, it is common, in “fast-food” establishments, for menu items to be associated with particular keys on a keypad, so that the store personnel can enter an order into a computer simply by pressing a few keys. The order can then be transmitted electronically to another station, and filled by other personnel. The computer prints a check showing the items purchased, the prices, and the total charge.

Computer-based ordering systems have also been tried in the context of full-service restaurants. It has been known, for example, to provide hand-held units, for each waiter or waitress, linked by wireless means to a server, wherein the orders placed by customers are transmitted to the server, or to some other station.

One example of a system used for automating the ordering process in a restaurant is given in U.S. Pat. No. 4,582,172, the disclosure of which is incorporated by reference herein.

The systems of the prior art are inadequate for dealing with the changing conditions in a busy restaurant. For example, there can never be an unlimited supply of any particular menu item, and some items may become depleted quickly. When that happens, the waiter or waitress may not know that an item is no longer available until being told by kitchen staff. In the past, this situation requires the waiter to return to the customer's table and inform the customer that the item is no longer available.

If the waiter takes the order and does not inform the customer of the unavailability of an item until several minutes, or more, have passed, the customer is likely to be disappointed and angry.

On the other hand, if the waiter knows, when the customer places the order, that an item is no longer available, he can inform the customer immediately. The customer might be disappointed, but the disappointment would normally be minimal because the customer is not led to believe, even for a short time, that the item was available.

The present invention provides a system and method for overcoming the above-described problem. The invention provides an automated ordering system that gives waiters, waitresses, and bartenders almost instantaneously updated knowledge about the state of the restaurant menu.

### SUMMARY OF THE INVENTION

The present invention comprises a system and method for management of a restaurant or bar. In one preferred embodiment, the system includes a server computer, and a plurality of client computers, the client computers communicating with the server by wireless means. The client computers preferably include a plurality of wireless hand-held units, to be used by waiters and waitresses, and one or more stationary touchscreen units, preferably also connected to the server by wireless means. The stationary units can be used either by managers or by waiters and waitresses, or both.

A copy of the restaurant menu is stored in the server, and also in local copies stored in the various clients. Orders can be placed through the various clients, the orders being transmitted to the server, and printed on a printer selected by the person entering the order. When a permanent change in the menu is made at the server, the change is automatically reflected in all of the local copies stored in the clients, as soon as the clients make their next contact with the server. Users of the system are notified that a change has been made. The local copies of the menu, stored in the clients, can also be changed to reflect temporary modifications of the menu. For example, a menu item can be disabled when the supply of that item has been exhausted. When a menu item has been disabled, the system will not accept further orders for the item. In all cases, the local copies of the menu, stored on the client computers, are synchronized with the master copy stored in the server.

The system also enables a manager to place a menu item “on count”. The manager enters a quantity remaining, for a particular menu item, and that quantity is automatically displayed on the local menus on all of the client computers. As orders are placed for that item, the count is decremented. When the count reaches zero, further orders for the item are rejected.

The system also enables checks and/or credit card receipts to be printed on any of a variety of printers, selected by the waiter. These items may even be printed by the hand-held unit itself. Also, if the selected printer is unavailable, the printing job is automatically diverted to a previously designated backup printer.

The present invention therefore has the primary object of providing a computerized system and method for managing a restaurant or bar.

The invention has the further object of enhancing the efficiency of operation of a restaurant or bar, by automatically providing each staff person with an updated version of a menu.

The invention has the further object of enhancing the efficiency of operation of a restaurant or bar, by automatically providing each staff person with information about the quantity remaining of one or more menu items.

The invention has the further object of increasing the satisfaction of customers of a restaurant or bar, by providing instantaneous menu information to waiters and waitresses, through hand-held wireless units used to take orders.

The invention has the further object of improving the operation of a restaurant by enabling staff persons to select remotely a printer that will print an order, a check, or a credit card receipt.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a schematic diagram showing the elements of the system of the present invention.

FIG. 2 provides a flow chart showing some of the programming of the system of the present invention, wherein an item on the restaurant menu is permanently modified by a manager.

FIG. 3 provides a flow chart showing the programming of the system of the present invention, wherein an item on the restaurant menu is temporarily enabled or disabled.

FIG. 4 provides a flow chart showing the programming of the system of the present invention, wherein an item on the restaurant menu is placed “on count”, to indicate a limited quantity of the item.

FIG. 5 depicts a sample screen display, as viewed by a manager who wishes to add an item to a restaurant menu, according to the present invention.

FIG. 6 depicts a further screen display, showing a sub-screen for adding an item to a restaurant menu, according to the present invention.

FIG. 7 depicts a screen display after a manager has added “Salmon” to the menu, according to the present invention.

FIG. 8 depicts a screen display on the hand-held units used in the present invention, indicating to a waiter that a change has been made to the restaurant menu.

FIG. 9 depicts a screen display on the hand-held units used in the present invention, showing how the first line of a message is displayed to a user.

FIG. 10 depicts a screen display showing how the system of the present invention notifies a waiter, through one of the hand-held units, of the specific change recently made to the restaurant menu.

FIG. 11 depicts a screen display, appearing on the hand-held units carried by the waiters, following the example of FIGS. 5-10, showing that “Salmon” has been added to the restaurant menu.

FIG. 12 depicts a screen display shown on one of the stationary touchscreen units, indicating that a change has been made to the menu.

FIG. 13 depicts a screen display, showing how a manager can temporarily disable an item from the restaurant menu, according to the present invention.

FIG. 14 depicts a screen display, from one of the stationary touchscreen units, showing how the system notifies the user that the status of a menu item has changed.

FIG. 15 depicts a screen display, showing how a manager can restore an item to the restaurant menu, according to the present invention.

FIG. 16 depicts a screen display, showing the message that appears on the hand-held units, indicating the disabling of an item from the restaurant menu, according to the present invention.

FIG. 17 depicts a screen display, as seen on the hand-held units, showing a disabled item in parentheses, according to the present invention.

FIG. 18 depicts a screen display, as seen on the stationary touchscreen units, showing a message indicating the change in the status of a menu item.

FIG. 19 depicts a screen display, as seen on a stationary unit provided by the present invention, indicating that a menu item is unavailable.

FIG. 20 depicts a screen display, as seen on a stationary unit provided by the present invention, showing how a manager can place a menu item “on count”.

FIG. 21 depicts a screen display, as seen on a hand-held unit provided by the present invention, showing a message indicating that a change has been made in the status of a menu item, as a result of placing the item “on count”.

FIG. 22 depicts a screen display, as seen on a hand-held unit provided by the present invention, showing the quantity remaining for a menu item that has been placed “on count”.

FIG. 23 depicts another screen display, as seen on a hand-held unit provided by the present invention, showing a revised menu which indicates the quantity remaining for a menu item.

FIG. 24 depicts a screen display, as seen on one of the stationary touchscreen units of the present invention, showing a message indicating the quantity remaining of an item placed “on count”.

FIG. 25 depicts a screen display, as seen by a manager using the present invention to configure the printers located in a restaurant, the display showing the names and types of printers used to print checks or orders.

FIG. 26 depicts a screen display, as seen by a manager who is in the process of configuring the printers in the restaurant, the display showing how the manager can associate a type and default backup to a printer used with the present invention.

FIG. 27 depicts a screen display, showing how a manager can associate tables in a restaurant with a particular printer, according to the present invention.

FIG. 28 depicts a screen display, as seen on one of the hand-held units of the present invention, showing how a waiter can choose the printer that will print a check or receipt.

FIGS. 29a-29c provide representations of sample orders, showing an embodiment in which an order from a given table is divided into multiple orders and printed at several locations, according to the nature of the items ordered.

### DETAILED DESCRIPTION OF THE INVENTION

As used in the present specification, the term “menu” means a listing of food and/or beverage items, as is provided in a restaurant or bar. The term “server” means a computer, or equivalent device, used to store and provide information to one or more “client” machines. The terms “waiter” or “waitress” will be used to refer to the actual persons who attend to customers in a restaurant or bar. The expression “click” on an item means that the user selects that item, either with a computer mouse, by a touchscreen interface, by a keyboard entry, by a stylus, or by any other equivalent means. The term “press a button” has the same meaning as to “click” on a button.

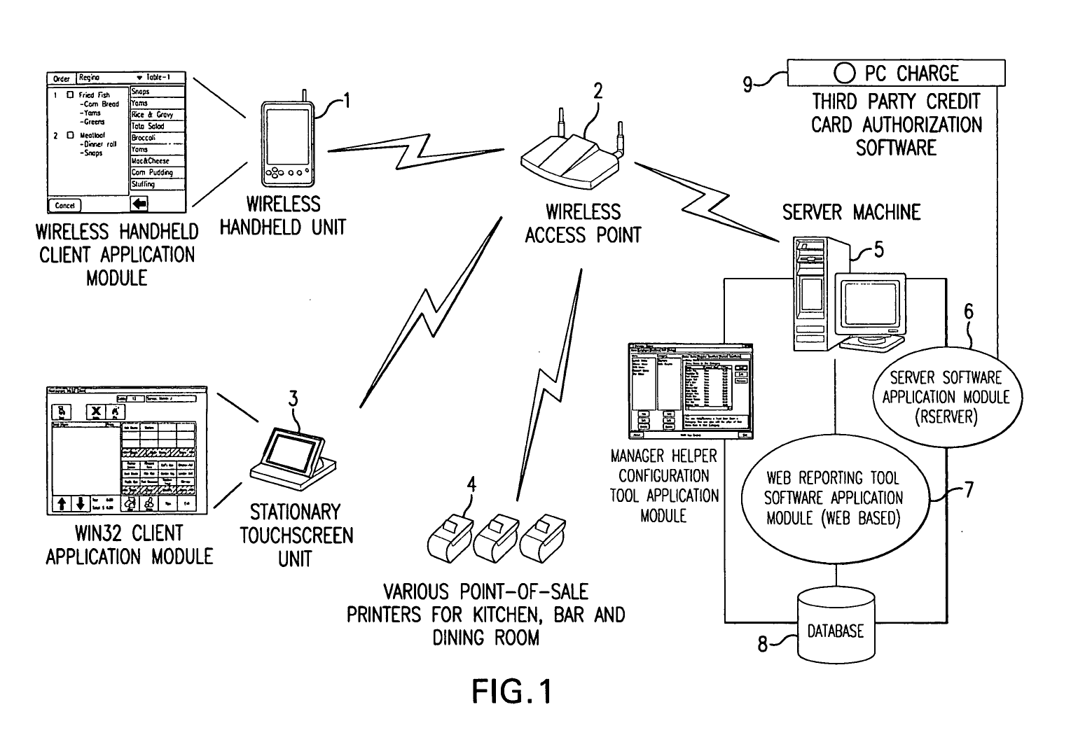

FIG. 1 provides a schematic diagram of the components of the present invention. In brief, the system includes one or more wireless hand-held units 1, one or more stationary touchscreen units 3, one or more point-of-sale printers 4, and a server 5. These components are linked, preferably in a wireless manner, through wireless access point 2. FIG. 1 depicts, adjacent to wireless hand-held unit 1, a sample screen display that could be generated by such unit. Similarly, the figure depicts, adjacent to the stationary touchscreen unit 3, a sample screen display for that unit. A similar display is shown adjacent to the server 5. The details of sample screen displays are explained later.

The server is shown to be operatively connected to server software application module 6. Module 6 represents software which can be loaded on the server itself, or provided through other means. The server may also be linked to a web reporting application module 7, and to database 8. The application module 7 may include various utility programs useful in the management of a restaurant, including software for reporting on gross sales, times worked by each employee, and inventory. Module 7 may be provided through an Internet interface, i.e. by operating a browser program, or it could be an independent program stored and operated in server 5.

The wireless hand-held units 1, and the stationary touchscreen units 3, are programmed to display, to the user, a menu of items available at the restaurant, and to receive orders for such items, and to transmit those orders, if desired, to a kitchen or elsewhere. Transmitted orders are printed at the destination location, such as the kitchen or bar, so that the orders can be read and filled by kitchen or bar personnel. The hand-held units may also be programmed to generate a check or bill electronically, for printing on printers 4 or elsewhere. Alternatively, the hand-held unit may include its own printer, so that checks and/or credit card receipts can be printed directly by the hand-held unit. The hand-held units thus may also include the ability to receive a credit card and to process the information on the card. Credit card software 9 is shown operatively connected to the server software application module 6. The software 9 may be provided remotely, or may be programmed into the server.

Both the hand-held units and the stationary touchscreen units are capable of providing the same basic functions of order-taking and processing. In many cases, the hand-held units may be preferred by waiters and waitresses, as they can be carried conveniently as the waiter or waitress moves from one table to another, or from the dining area to the kitchen and back. In other cases, the stationary touchscreen units are preferred. A stationary touchscreen unit is more likely to be preferred by a bartender, who generally does not need to travel repeatedly back and forth between a kitchen and a dining area. There may be other situations, in a restaurant, in which a waiter or waitress may prefer to walk to a stationary touchscreen unit, instead of carrying a hand-held unit. In general, the stationary touchscreen units can perform all of the functions performed by the hand-held units, plus various managerial functions described below.

The basic details of operation of the hand-held units and stationary touchscreen units, insofar as they constitute means for taking and relaying orders, and for generating bills or checks, are within the level of ordinary skill in the art, as exemplified by the above-cited U.S. Pat. No. 4,582,172, and therefore will not be repeated here. It is understood that many variations of the order-taking process could be incorporated into such units.

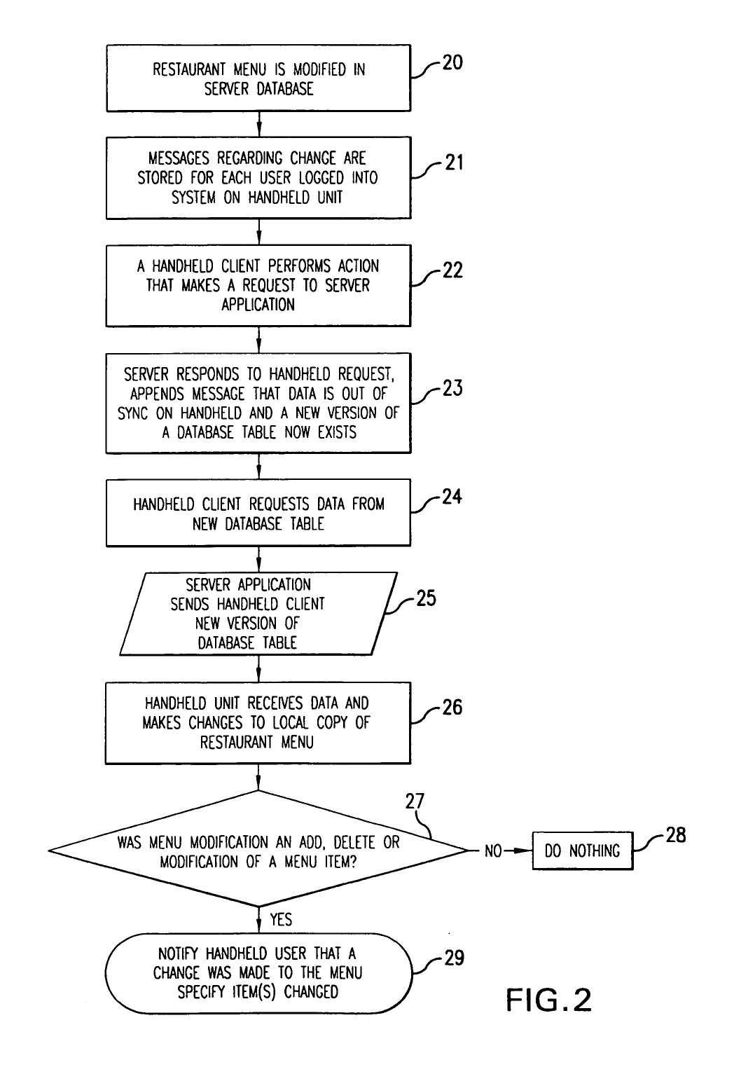

FIGS. 2-4 comprise flow charts which illustrate the programming of the unique features of the present invention. The major improvements provided by the present invention are as follows:
1. The present invention enables all of the wireless hand-held units 1, and all of the stationary touchscreen units 3, to be linked to a central database, such as database 8 associated with server 5, the database containing a menu of items available at the restaurant;
2. The system provides means for quickly and continuously updating the status of the menu, such that all units connected to the system will display current and updated information to waiters and waitresses; and
3. The system provides means for alerting users of the system, including all waiters and waitresses, concerning the quantity remaining of selected menu items.

The system of the invention also provides other innovative features, such as the ability to print a check or credit card receipt, either at a nearby printer, or at some other printer specifically chosen by the waiter, or on a hand-held unit if that unit is equipped with a printer. The invention also enables a manager to make permanent changes to the restaurant menu.

FIG. 2 illustrates part of the programming of the system, in one preferred embodiment. FIG. 2 represents the software that permanently modifies the content of the restaurant menu. In block 20, the restaurant menu is modified in the server database. This modification, which could be the permanent addition or deletion of a menu item, is accomplished by modifying database 8, using the server 5. This modification would normally be made by a manager, at the server location. In the preferred embodiment, this type of modification cannot be made through the hand-held units 1 or the stationary touchscreen units 3.

In block 21, messages reflecting the change made by the manager in block 20 are generated and stored for each user logged into the system through a hand-held unit. But, so far, the messages have not been seen by the users of the hand-held units.

In block 22, a hand-held unit performs an action that generates a request to the server. Such an action could include the placement of an order, or any other request.

In block 23, the server responds to the request made through the hand-held unit, and appends a message indicating that the local menu stored in the hand-held unit is out of date. In block 24, the hand-held unit, acting as the “client” of the server, requests updated information from the server. Such a request could be initiated automatically and internally, by the hand-held unit. For example, the hand-held unit may be programmed to interrogate the server at predetermined intervals, say, every sixty seconds, to obtain the latest version of the menu. Alternatively, the request made by the client could be initiated when the user clicks on, or otherwise selects, the message displayed on the hand-held unit.

In block 25, the server transmits an updated version of the restaurant menu data. In block 26, the hand-held unit receives the data from the server, and updates the local copy of the restaurant menu. Thus, the local copy becomes synchronized with the updated menu stored in the server.

In test 27, the system determines whether the change made by the manager was an addition to or deletion from the menu, or a modification of a menu item. If not, the system need not take action, as shown in block 28. If the answer to test 27 is yes, the server notifies the hand-held unit, in block 29, that a change was made to the menu, and specifies the change that was made. The notification may include the transmission of a message, generated on the hand-held units, as described above.

In an alternative embodiment, the system could be programmed to notify the hand-held units automatically of any changes to the menu, and to provide appropriate messages to the users. In this case, test 27 would be omitted, and the users would receive messages corresponding to every change.

In another alternative embodiment, the system could be programmed not to provide any messages regarding changes to the menu. Instead, the waiters would be made aware of such changes when they try to place orders for items that are no longer available, and find that such items have been removed. The hand-held units would still be notified, internally, of such changes.

In still another alternative embodiment, the system could be programmed to allow a manager to determine what changes should generate messages to be transmitted to, and viewed on, the hand-held units, and what changes should not be accompanied by such messages.

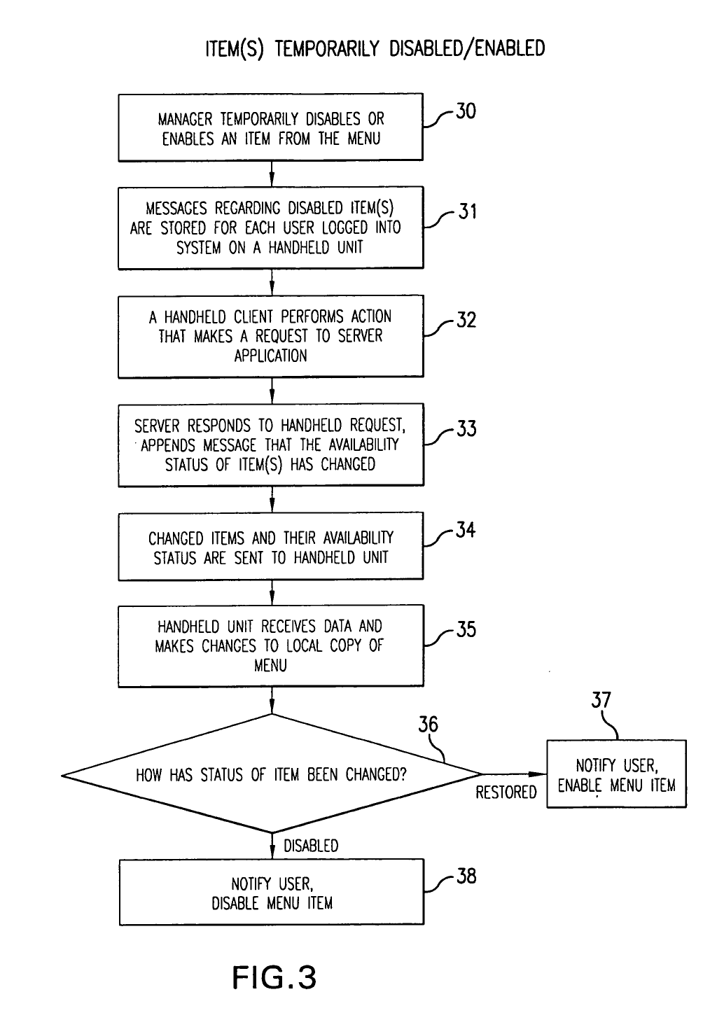

The menu modifications contemplated by FIG. 2 include permanently adding or deleting menu items. FIG. 3 deals with temporary changes, and shows how a manager can “enable” or “disable” a menu item. As used in this specification, the term “disabling” means temporarily removing an item from the menu. The most common reason for disabling an item would be that the supply of that item is exhausted. The term “deleting” means permanently removing the item from the menu. As shown in more detail below, one difference between “disabling” or “deleting” an item is that a disabled item still appears on the screen displays of the various hand-held units, and the stationary touchscreen units, but with an indication that the item is not available. A deleted item does not appear in any form.

The flow chart of FIG. 3 is generally similar to that of FIG. 2. However, in the preferred embodiment, the enabling and disabling of an item, represented by FIG. 3, is performed through one of the stationary touchscreen units 3, and not through the server 5.

In block 30, a manager temporarily disables or enables an item on the restaurant menu. In block 31, messages reflecting the change are generated and stored for each user logged onto the system through a hand-held unit. In block 32, a hand-held unit performs an action that triggers a request to the server. In block 33, the server responds to the request from the hand-held unit, and appends a message indicating that the availability of an item has changed. In block 34, a list of the changed items, and their availability status, are sent to the hand-held unit. In block 35, the hand-held unit receives the data and makes appropriate changes to its local copy of the restaurant menu.

In test 36, the system determines the nature of the change to the status of a menu item. If an item was restored or enabled, the system notifies the user, in block 37, and enables the menu item. If the item was disabled, the system, in block 38, notifies the user and disables the menu item.

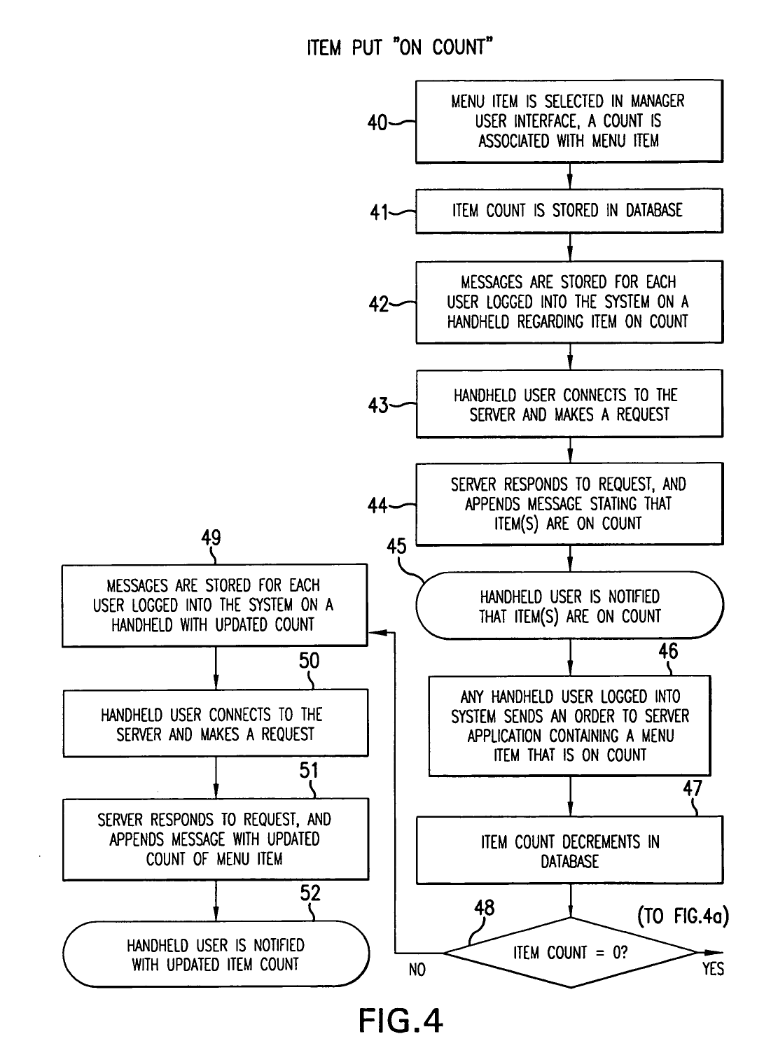

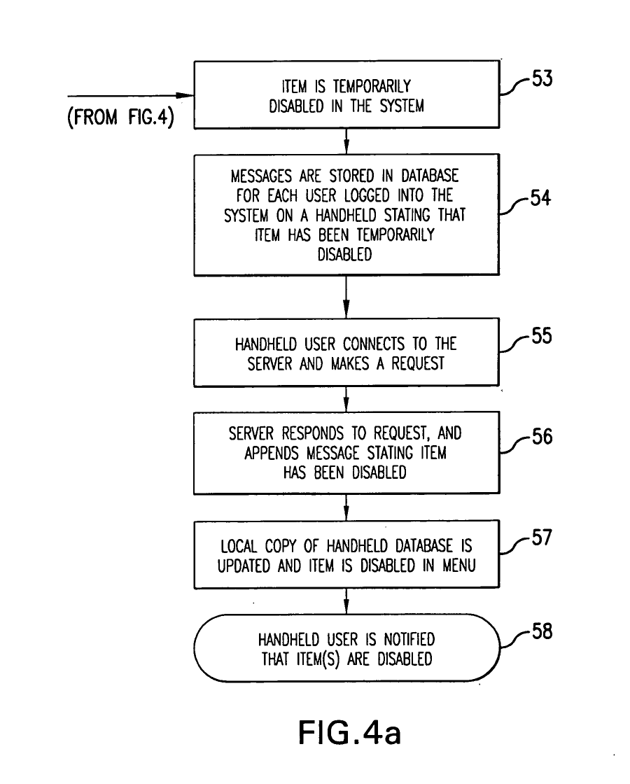

FIG. 4 shows the programming of the system of the present invention, with respect to the placement of a menu item “on count”. Placing an item “on count” means assigning a number to the item, to indicate the quantity of that item remaining in the kitchen. For example, if the item is chicken breast, and there are 15 chicken breasts remaining in the kitchen, the item can be placed “on count” with the starting number of 15.

In block 40, a menu item is selected, and a count is associated with that item. This function is performed on one of the stationary touchscreen units 3, normally by a manager. In block 41, the value of the count is stored in the database.

In block 42, messages are stored for each user logged into the system, on the hand-held units, regarding the item that has been placed on count.

In block 43, a hand-held unit makes a request to the server, such as the transmission of an order.

In block 44, the server responds to the request from the hand-held unit, and appends a message indicating that the particular item is on count. In block 45, the hand-held unit is notified that the item is on count.

Block 46 represents the transmission of an order, from any hand-held unit logged into the system, to the server, for a menu item that has been placed on count. In block 47, the server decreases the value of the count by one, and updates the value in its database.

In test 48, the system determines whether the value of the count has reached zero. If not, the system continues in block 49, which stores messages for each user logged into the system through a hand-held unit, the messages indicating an updated count value.

In block 50, a user of a hand-held unit transmits a request to the server. In block 51, the server responds to the request, and appends a message indicating the updated count value for the menu item. In block 52, the user of the hand-held unit is notified of the updated count value. Thus, through the action taken in block 52, a waiter or waitress will know the exact quantity remaining for a particular menu item that has been placed on count, even while the customer is placing the order.

If the value of the count has reached zero, the system continues with block 53, where the item in question is temporarily disabled in the system. In block 54, messages are stored in the database for each user logged into the system through a hand-held unit, indicating that the item has been temporarily disabled.

In block 55, the hand-held unit connects to the server and makes a request, such as in the transmission of an order. The server responds, in block 56, appending a message indicating that the particular item is disabled. In block 57, the local copy of the database stored in the hand-held unit is updated, so that the item in question is disabled on the menu. The user of the hand-held unit is notified of the change, in block 58.

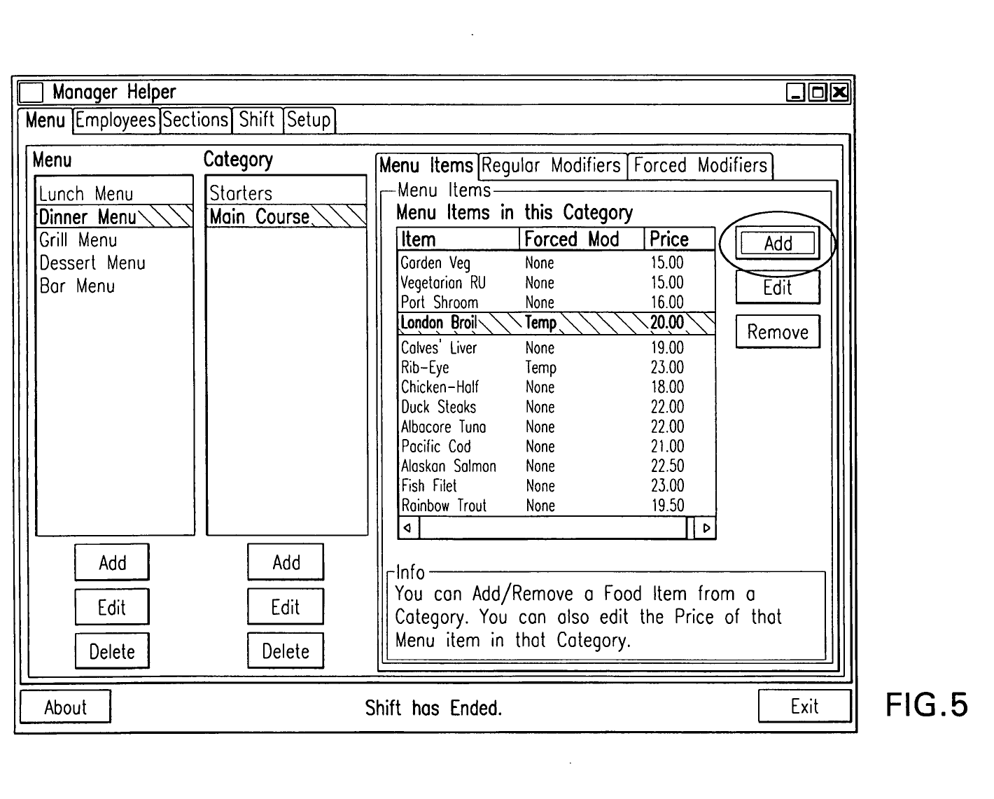

FIGS. 5-24 depict various screen displays that are typically shown to users of the system, while practicing the method of the present invention. These figures further illustrate the features described in the flow charts of FIGS. 2-4.

FIG. 5 represents a typical screen display, generated by the “Manager Helper” software that is loaded on the server 5. The manager uses the Manager Helper software module to make permanent changes to the restaurant menu. This software may be accessed at the location of the server 5, or, more preferably, at any of the various stationary touchscreen units 3.

The display shown in FIG. 5 shows that the manager is viewing the “Dinner Menu”, and the category “Main Course”, the latter fields having been highlighted on the left-hand side. The menu items pertaining to main courses on the dinner menu are shown on the right-hand side. Each item is shown adjacent to a column of “forced modifiers”. A forced modifier is a property of the menu item that the waiter is obligated to enter. For example, “London Broil” is associated with the forced modifier “Temp” (for “temperature”), indicating that the waiter must specify whether the food is to be “well done”, “rare”, etc. A “regular modifier” is a property of the menu item which is optional, and which the waiter may enter, as part of an order, at the request of a customer. The manager can click on the indicated tabs to view and edit the regular and forced modifiers.

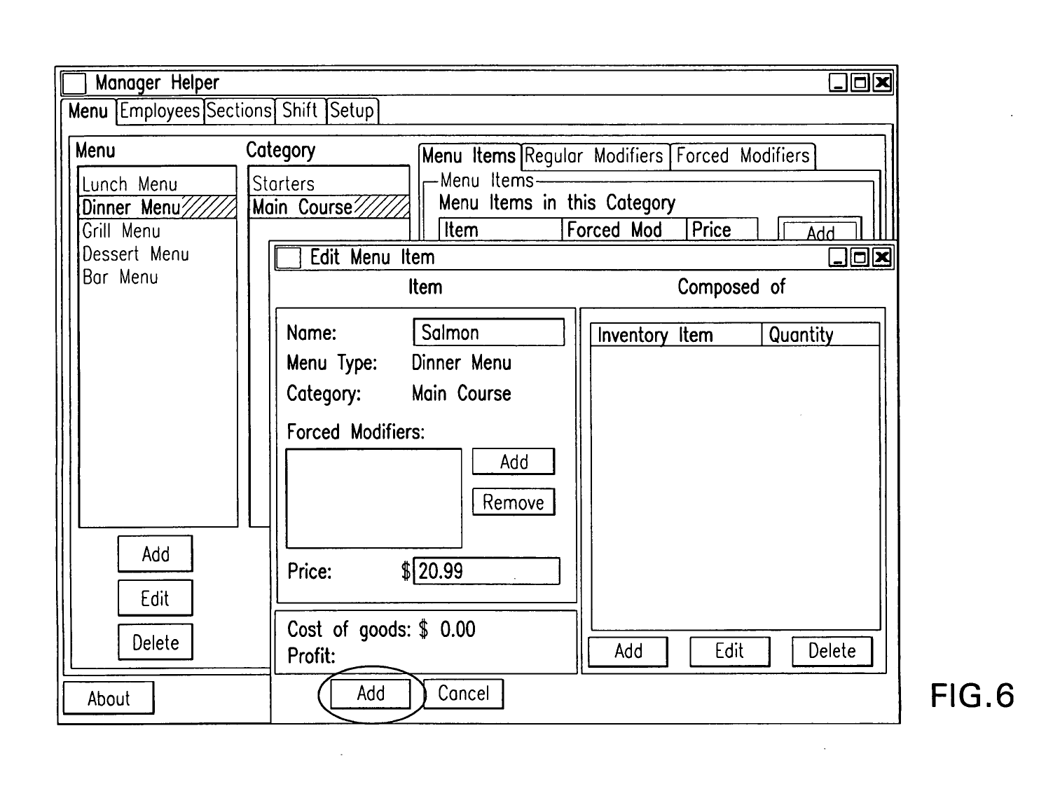

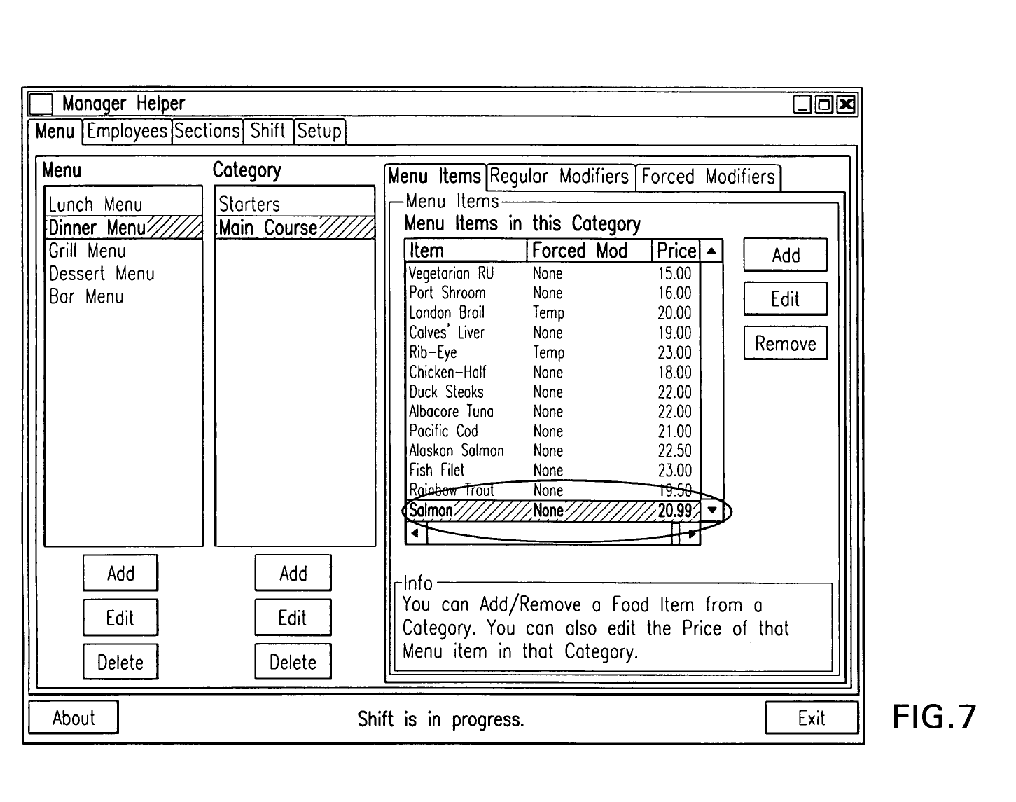

To add an item to the menu permanently, the manager presses or clicks on the “Add” button, which is encircled in FIG. 5. The system responds with a second screen, shown in FIG. 6, onto which the manager can enter the new menu item, using a keyboard associated with the server. In the example shown, the item to be added is “Salmon”. After entering the details associated with this item, the manager presses the “Add” button, shown encircled in FIG. 6. The result is shown in FIG. 7, wherein “Salmon” now appears as one of the menu items on the dinner menu.

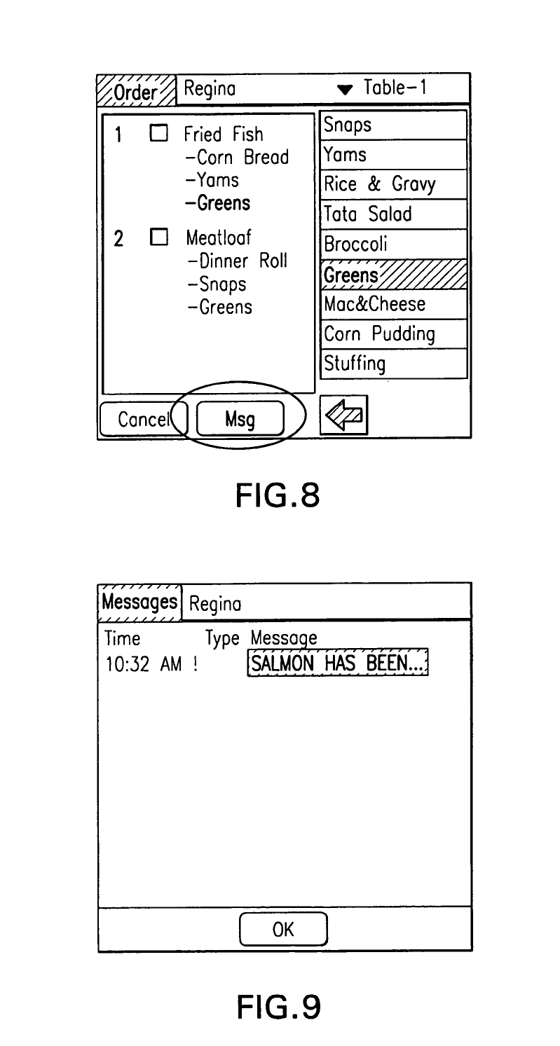

During the next client-initiated connection to the server, the client machines are notified of the menu change. The “clients” include both the hand-held units 1 and the stationary touchscreen units 3. The notification may be made, at least in part, by sound. For example, the client machines may be programmed to generate two short beeps. They are also preferably programmed to display a “Message” button that appears at the bottom of an “Order” screen. A typical such order screen, as would be seen on one of the hand-held units, is shown in FIG. 8.

The order screen shown in FIG. 8 also shows the name (“Regina”) of the user who has logged into the system from that particular hand-held unit. The screen provides a complete listing of the menu items, and allows the user to highlight and select those items to generate an order. The Message button appears at the bottom.

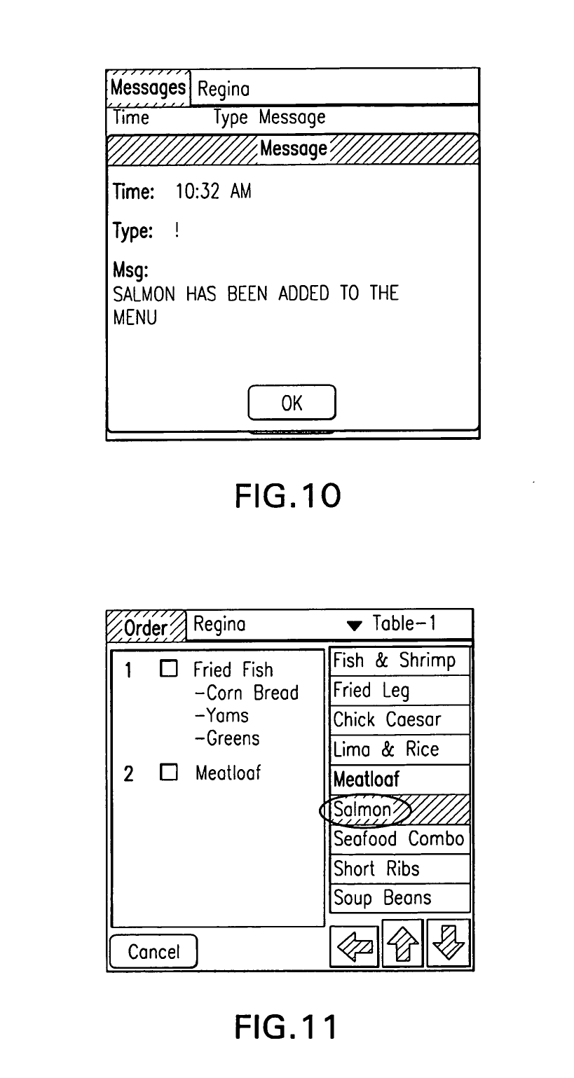

When the user clicks on the message button, the user is presented with the first line of the message, as shown in FIG. 9. The reason for presenting only the first line is that, in general, there may be more than one message. By initially showing only the first line of the message, the system can present a list of messages on a single screen. The user can view the entire message by clicking on the desired message. Doing so generates a dialog box that contains the entire message, as shown in FIG. 10. In this example, the message is that salmon has been added to the menu.

FIG. 11 represents the screen display on the hand-held unit, after “salmon” has been added to the menu. The new menu item automatically appears in the local copy of the hand-held unit's menu, the next time the user browses the menu on the hand-held unit.

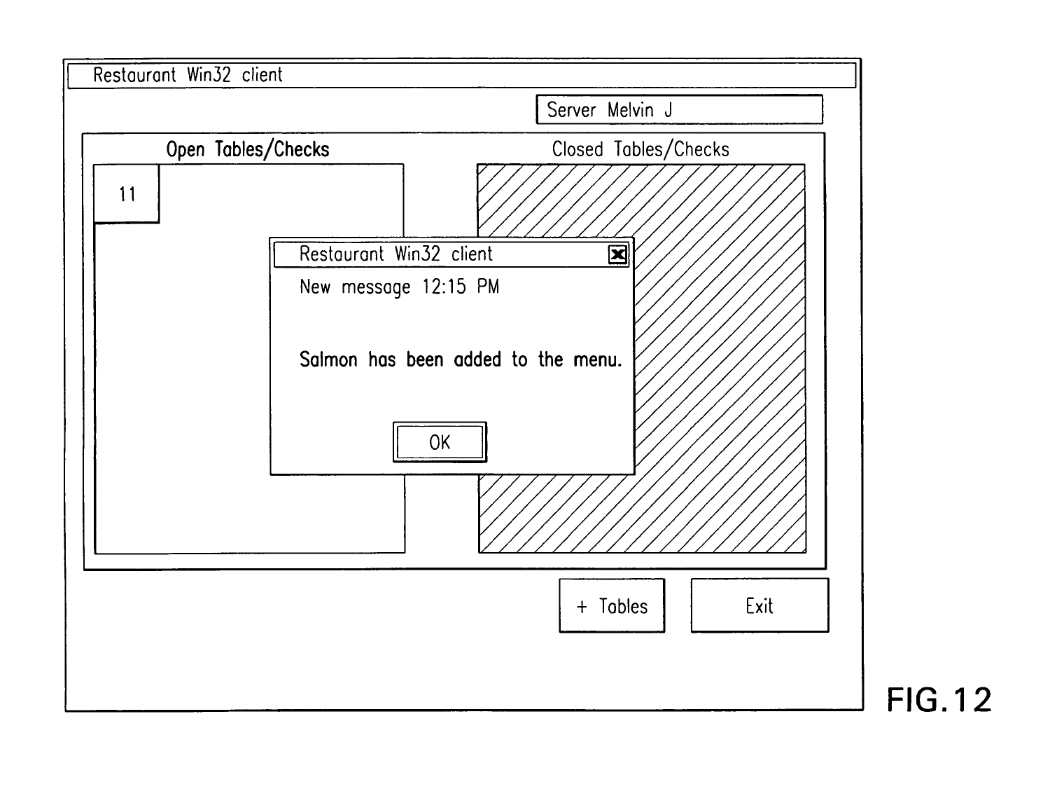

A similar message is preferably displayed on the stationary touchscreen units 3, indicating the addition of the item to the menu. The message as it appears on the stationary touchscreen unit is shown in FIG. 12. The new information now appears in the local copy of the menu stored in the touchscreen unit.

The displays described so far relate to the permanent addition or deletion of a menu item. As explained above, the present invention also allows managers to enable or disable existing menu items temporarily. The figures described below further illustrate this feature.

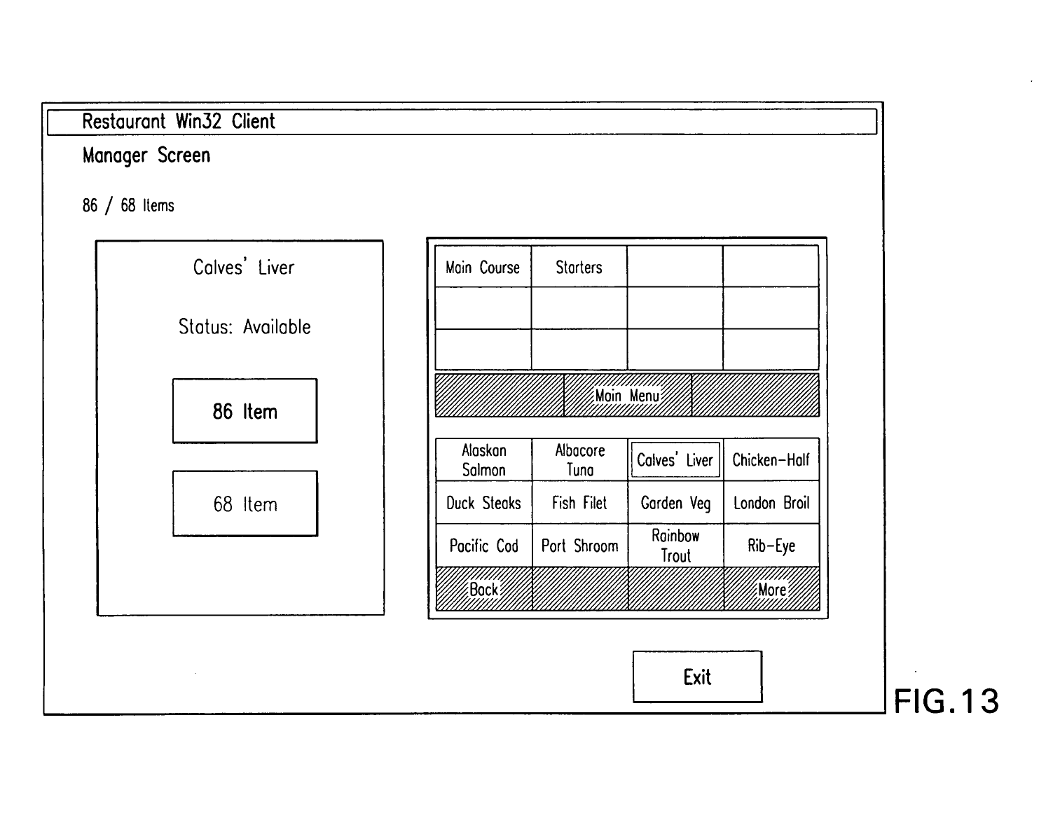

FIG. 13 depicts a typical display that appears on one of the stationary touchscreen units 3. This display, titled the “Manager Screen”, allows the manager to access any item on the menu, and to enable or disable that item. In the example given, the manager has chosen “Main Course” from among the buttons at the upper right-hand side, and the corresponding menu items appear as buttons at the lower right-hand side. To disable an item, the manager selects the item, and presses the button labeled “86 Item”. In the restaurant trade, the term “86” is typically used to indicate disabling of a menu item, and the term “68” is used to indicate restoration of an item. When the manager presses a button to enable or disable an item, a message appears, confirming that the status of the item in the system has changed.

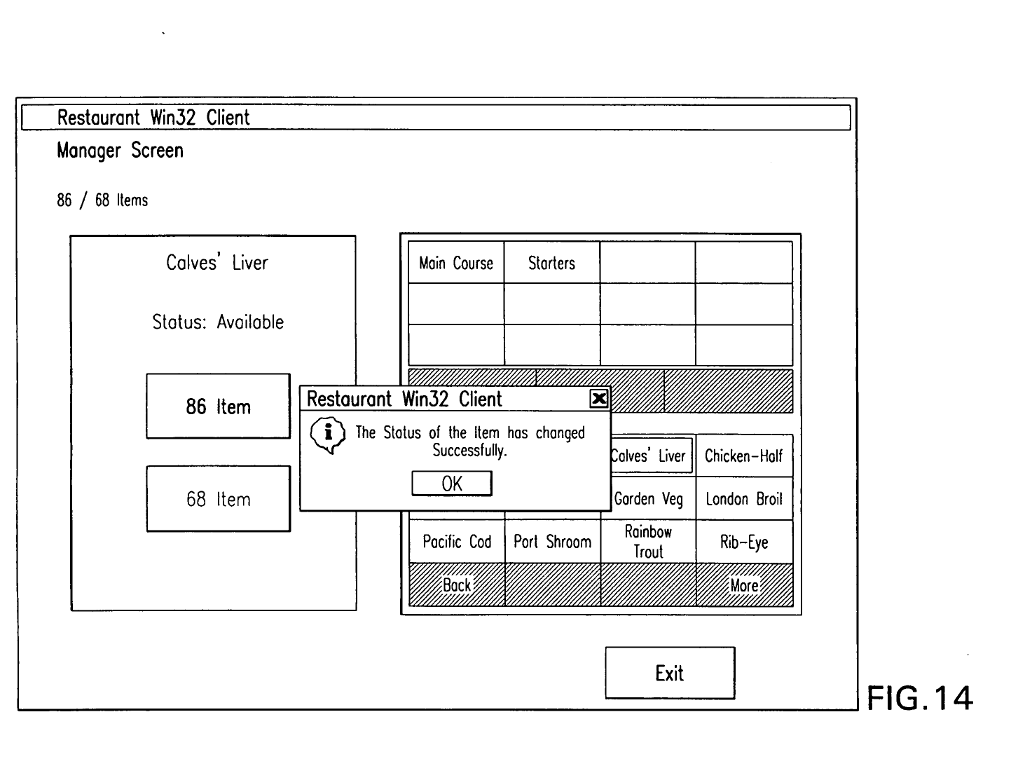

In the example represented in FIGS. 13-15, the manager wishes to disable “Calves' Liver” from the menu. As shown in FIG. 13, the manager highlights this menu item, and the left-hand side indicates the status of “Calves' Liver”. Since calves' liver was originally available, FIG. 11 shows the “86 Item” button as available, and shows that the “68 Item” button is grayed out (i.e. unavailable for use). When the manager presses the “86 Item” button, a message appears, confirming that the status of the menu item has changed, as shown in FIG. 14.

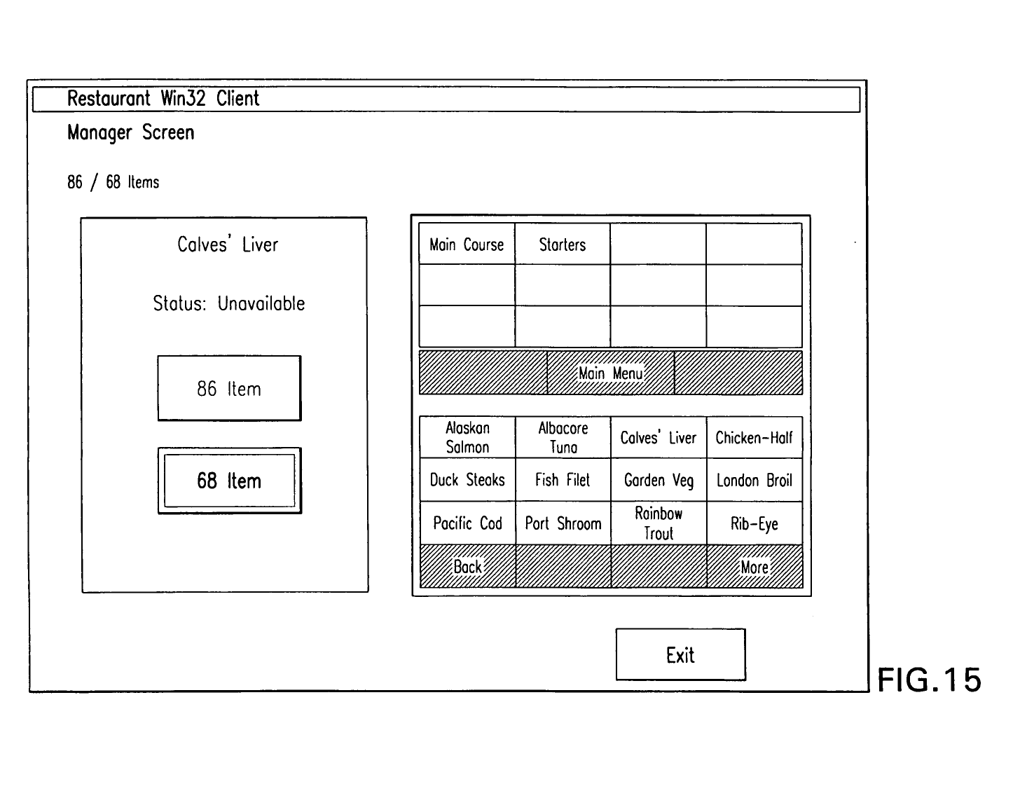

In FIG. 15, the status of calves' liver is now indicated as unavailable, and the “86 Item” button is grayed out, while the “68 Item button” is available for use. Thus, FIG. 15 shows that the manager now has the option of restoring calves' liver to the menu.

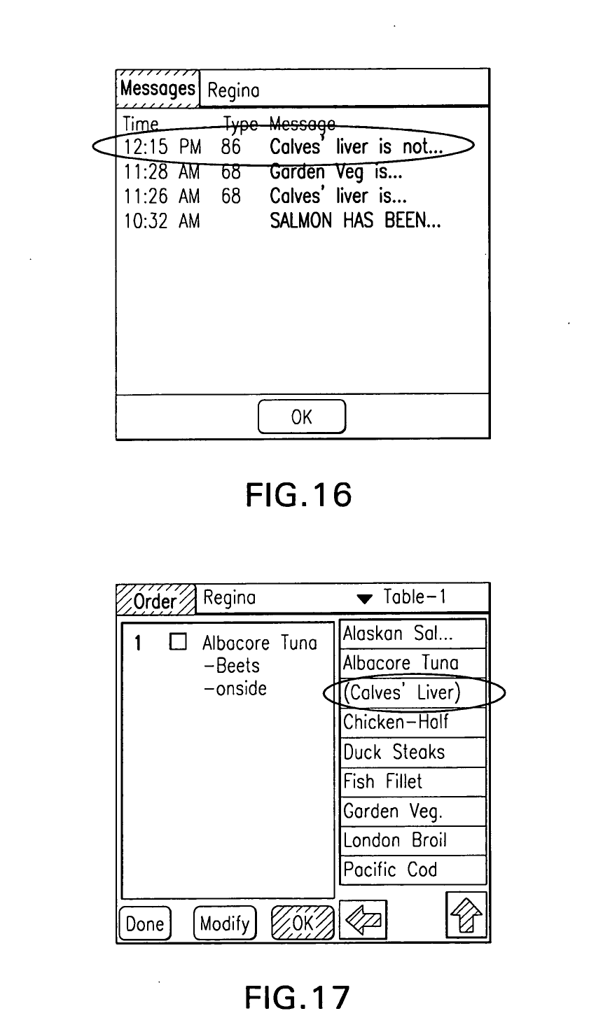

FIGS. 16 and 17 illustrate the corresponding displays appearing on the hand-held units 1, following the change made by the manager. During the next client-initiated connection to the server, the hand-held unit receives the updated menu. A “Message” button appears on the ordering screen. When the user presses the Message button, the user sees a display such as that shown in FIG. 16, listing the pending messages. For emphasis, the message pertaining to the above example (the unavailability of Calves' liver) is encircled. To view the full text of a message, the user must click on that message, as described earlier. In this example, the full text of the message is not reproduced in the figures. FIG. 17 shows the ordering screen, on the hand-held unit, from which the waiter can generate an order. In the example shown, the item (calves' liver) that has been disabled is shown with parentheses to indicate its unavailability. This item is also encircled in the figure, for emphasis.

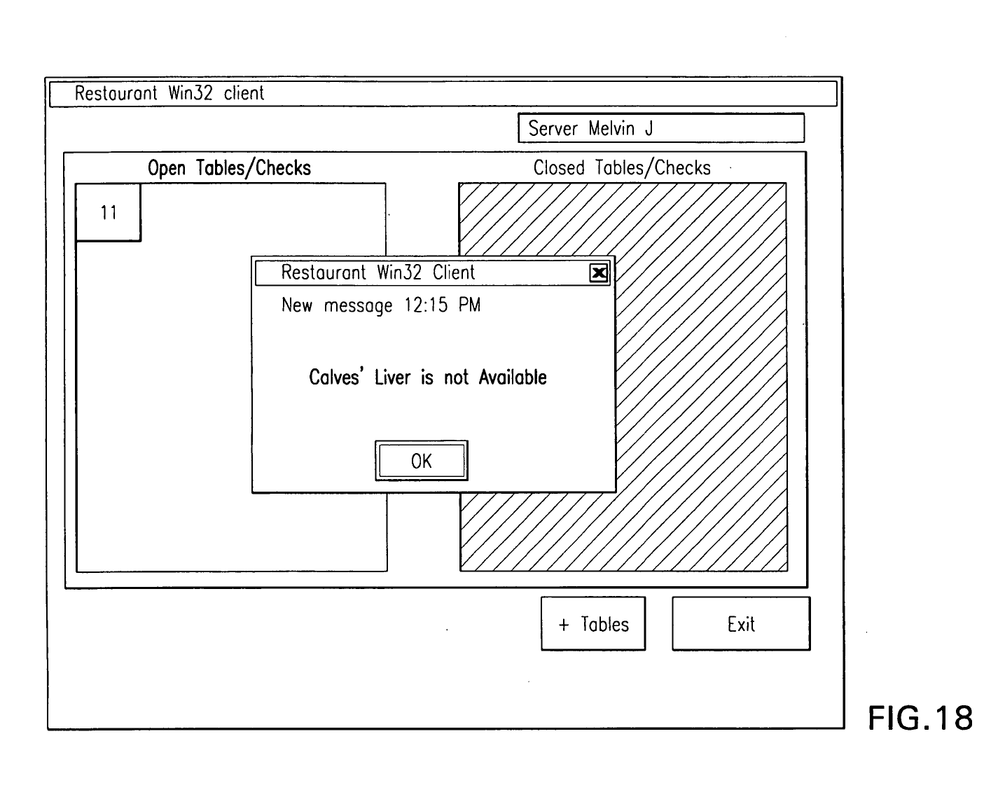

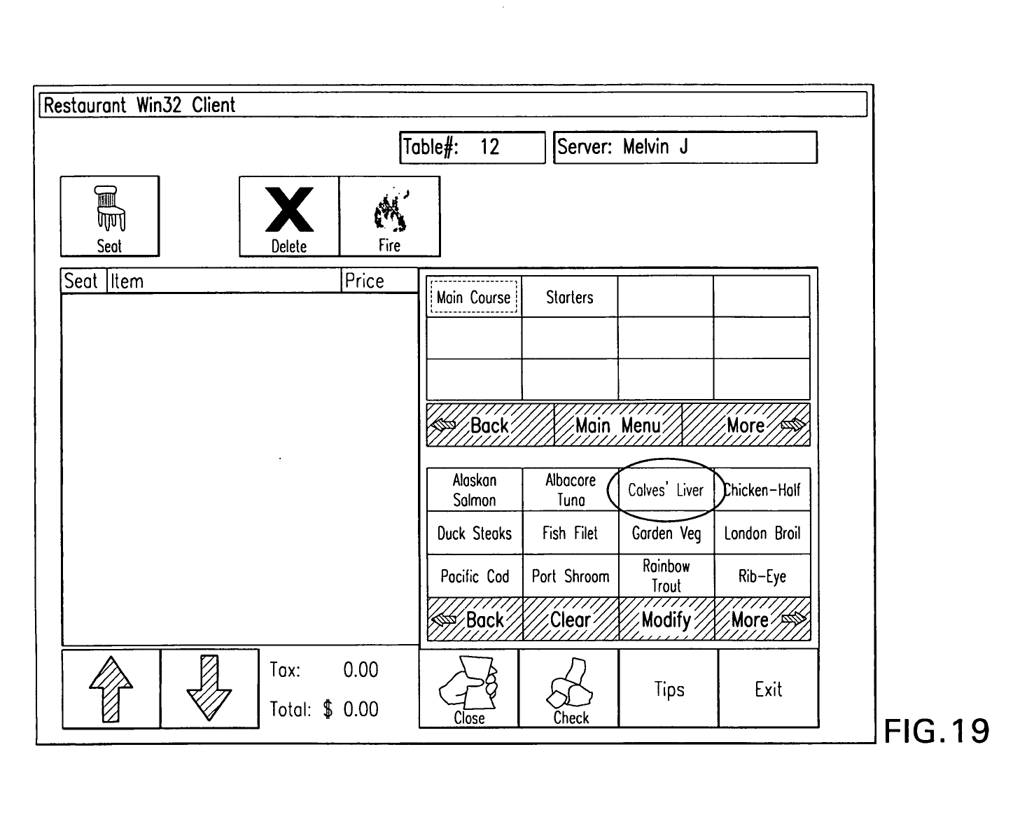

Similar updated information is transmitted to the stationary touchscreen units 3, during the next client-initiated connection to the server. The stationary touchscreen unit receives an updated version of the menu, and immediately displays a message, as shown in FIG. 18, indicating that the disabled item is not available. Moreover, as shown in FIG. 19, which represents an ordering screen, i.e. a screen from which an order can be generated using the stationary unit, the disabled item (calves' liver) has been grayed out, and therefore cannot be ordered. The disabled item is circled, in FIG. 19, for emphasis.

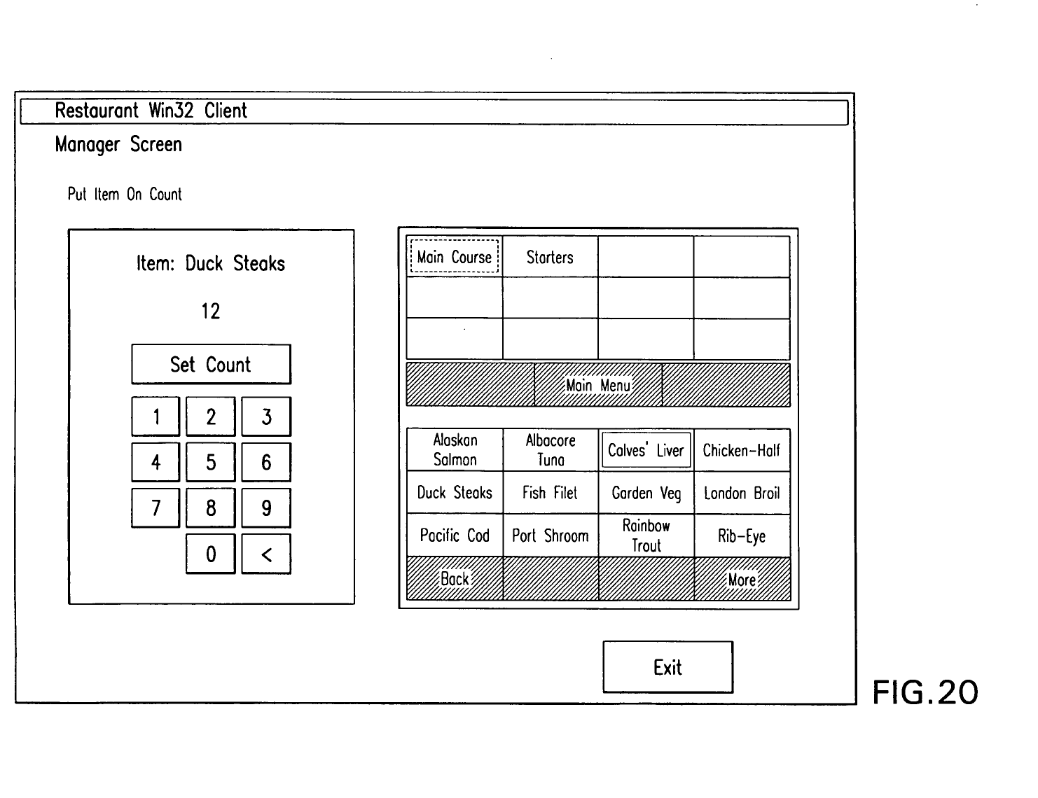

FIGS. 20-24 illustrate the process of placing a menu item “on count”. Using one of the stationary touchscreen units, a manager places an item “on count” so that the waiters and waitresses know the quantity remaining of an item that is in limited supply. Any or all menu items may be placed on count at any time. In practice, only some menu items, especially those that are expensive, in demand, and in limited supply, will be placed on count. But, in theory, every menu item could be placed on count, if the manager so desired.

The manager places an item on count in the following manner. First, the manager uses a main menu screen (not shown), generated by the software, to reach the screen labeled “Put Item on Count”, as shown in FIG. 20. The menu appears on the right-hand side, possibly divided by category. Thus, by clicking on “Main Course” in the upper right-hand screen, the manager sees a display of main courses in the lower right-hand screen.

The manager then browses the menu, as displayed, and selects the item to be placed on count. The manager enters the value of the count, using the numeric keypad that appears at the left-hand side of the screen, and presses the “Set Count” button. The manager then receives a confirmation (not shown) that the item has been placed on count.

Meanwhile, waiters and waitresses are given a message indicating that an item has been placed on count, and indicating the quantity remaining of that item. This message is generated when the item is first placed on count, and another message may be generated each time the count decreases when the item is ordered again. When the count of an item reaches zero, the item becomes automatically disabled. The system then treats the item in exactly the same way as if the manager had disabled the item. Thus, for example, the item will appear in parentheses on the hand-held units, etc. Moreover, if a waiter or waitress attempts to place an order for an item whose count has reached zero, that order will be rejected, and an appropriate message will be displayed on the hand-held or stationary unit used to place the order.

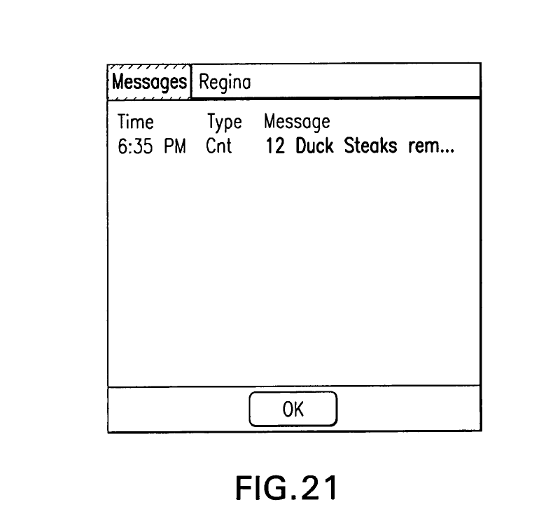

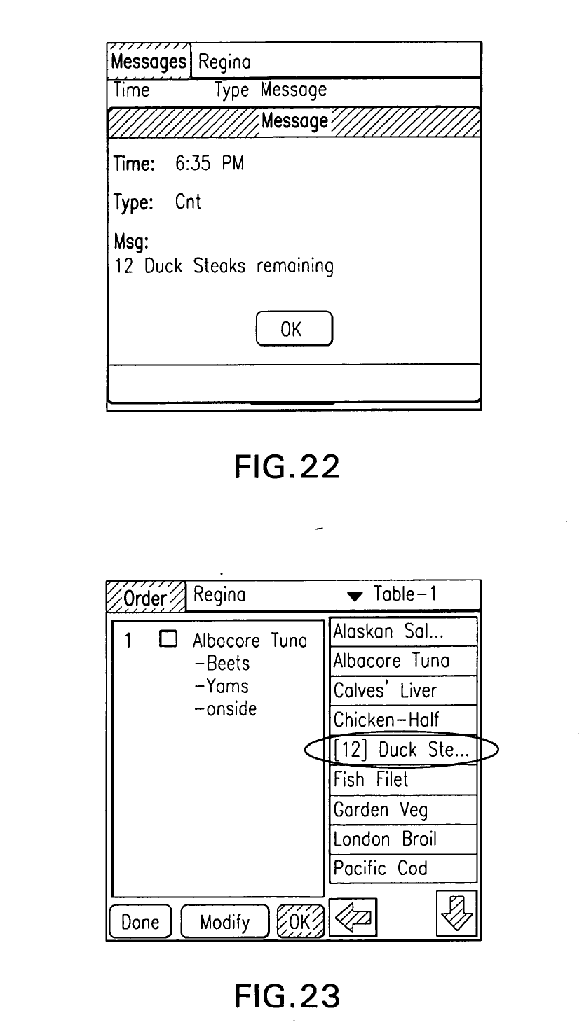

FIG. 21 illustrates the process of notifying users of the hand-held units of the status of an item placed on count. During the next client-initiated connection to the server, the remaining quantity of an item placed on count is reflected in the local copy of the menu stored in the hand-held unit. A “Message” button appears on the order screen, indicating the presence of a message. When the user presses the message button, the display may appear as shown in FIG. 21, which provides the first line of the message. By clicking on the message, the system displays the entire message, as illustrated in FIG. 22. Also, on the order screen, the system places the value of the count in parentheses, adjacent to the item in question. Thus, FIG. 23 illustrates the case in which 12 duck steaks remain in the kitchen. Thus, as the waiter takes an order, the count is visible, on the order screen, to the waiter as he takes the customer's order. If the waiter attempts to send an order to the kitchen containing a quantity of an item that is greater than the value of the count, the order is automatically rejected, and an error message is displayed to the user. And when the value of the count reaches zero, it is disabled on the local menu of the hand-held unit.

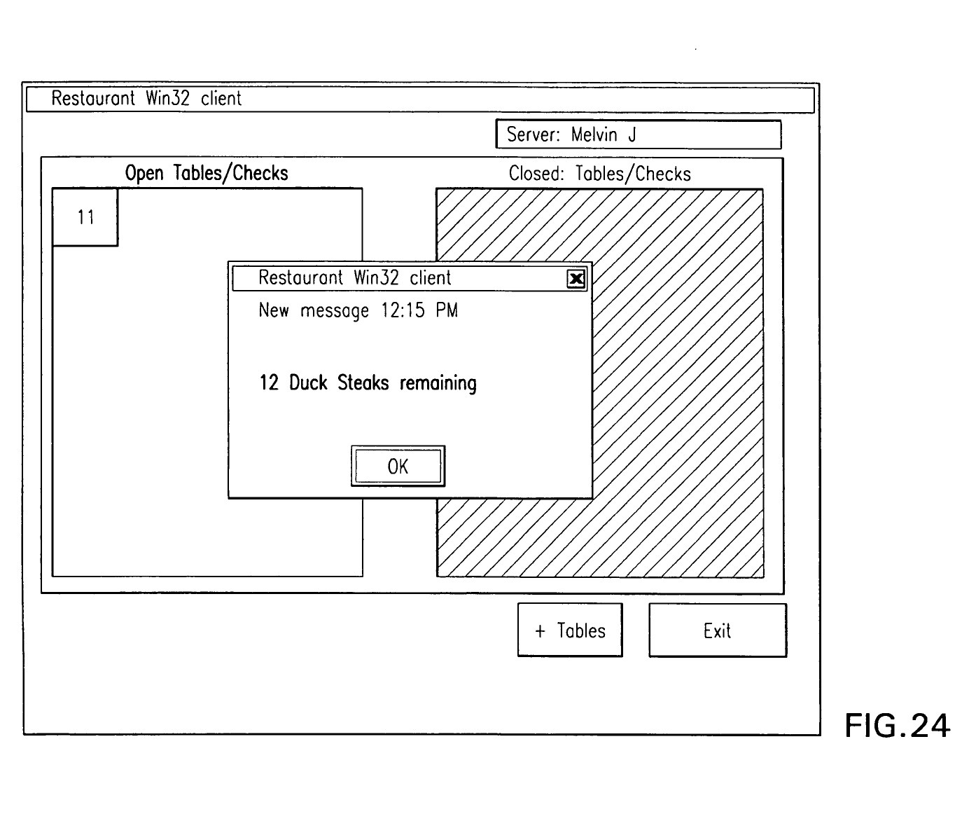

A similar process occurs in the stationary touchscreen units 3. Upon the next client-initiated connection to the server, a message is displayed, informing the user of the count of an item. FIG. 24 illustrates such a message. Also, in the preferred embodiment, the stationary touchscreen units enable a user to view the restaurant menu, and such menu will show updated counts for all items placed on count. The manner of displaying the updated counts, on the touchscreen units, may be similar to that shown with respect to the hand-held units. Also, when the count of an item reaches zero, that item becomes disabled, on the touchscreen menu, just as it is disabled on a hand-held menu.

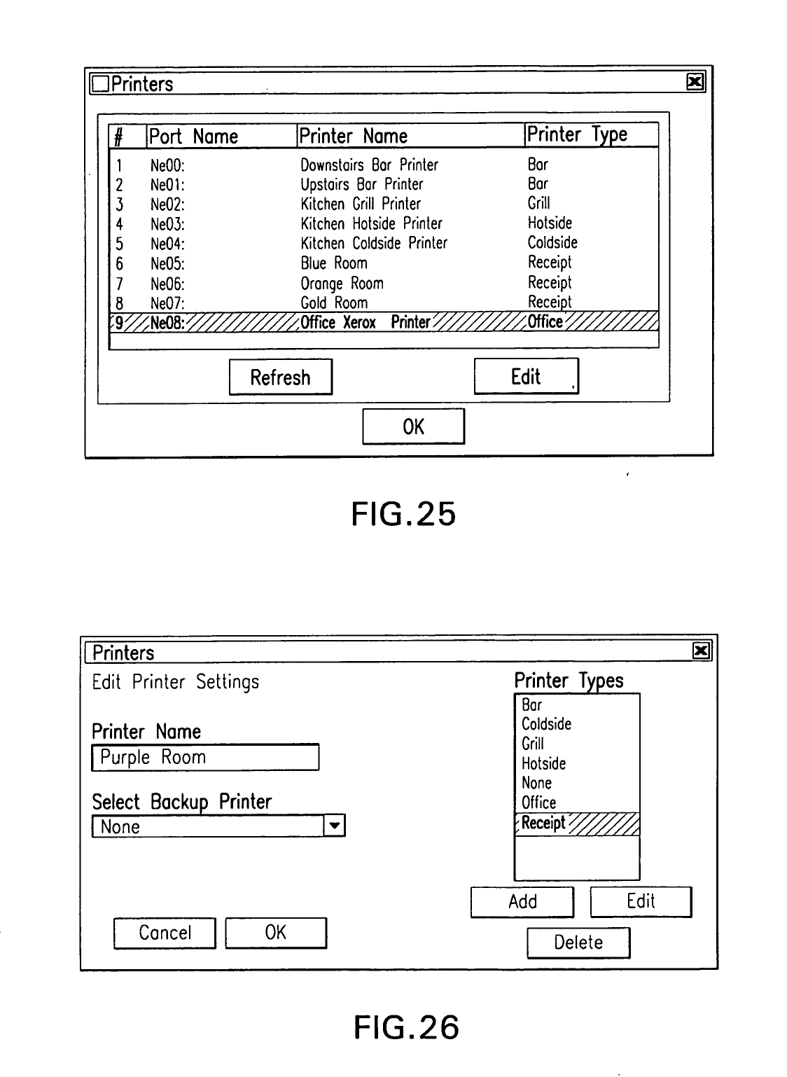

Another aspect of the invention, depicted in FIGS. 25-29, concerns the ability to manage the printing associated with operating a restaurant or bar. In general, there are three major kinds of documents to be printed, namely orders, checks, and credit card receipts. The term “orders” refers to descriptions of what a customer has ordered. If the order is for food, it is normally transmitted to, and printed in, the kitchen, or section of the kitchen, where the food will be prepared. If the order is for an alcoholic beverage, it should be transmitted to, and printed at, the bar, where the bartender can see the order and prepare the requested item. It is an important feature of the present invention that orders, checks, and credit card receipts can be printed at printers selected by the staff, at locations throughout the restaurant or bar.

In managing a restaurant, it is common to divide the establishment into “sections”. Each section is a group of restaurant tables, and each waiter is generally responsible for all the tables in the section. Normally, a waiter does not serve tables outside his section, unless there is a special need to do so. The number of sections in the restaurant is known as a “section configuration”. For example, if there are eight waiters available to work in the restaurant, the tables would be arranged in a configuration having eight sections.

In the present invention, a printer is preferably assigned to each section. When a waiter prints a check or a credit card receipt for a particular table, the item is normally printed at the printer assigned to the section in which that table is located. But the invention allows the waiter to choose to print the item at any other printer.

Assignment of a printer to a section is done through the “Manager Helper” software discussed earlier, and normally operated through one of the stationary touchscreen units 3. This software is configured to allow the manager to assign a descriptive name to each printer in the network, and also to label the printer by its type, such as “Bar”, “Kitchen”, “Receipt” etc. FIG. 25 shows a sample screen display, depicting the various printers in a hypothetical restaurant, and indicating the type of printer for each.

As used in this description, the term “type” does not refer to the mechanical features of the printer, but rather to the manner and location in which the printer is used. In the example of FIG. 25, the printer types labeled “Bar”, “Grill”, “Hotside”, and “Coldside” are all printer types relating to the taking of orders. If a customer orders an alcoholic beverage, the waiter directs the order to a “Bar”-type printer. If a customer orders a cold sandwich, the order may be directed to the “Coldside” section of the kitchen, etc. The printer labeled “Receipt” is intended for printing checks and credit card receipts. In the example of FIG. 25, the kitchen is large enough that it can be subdivided and served by different printers. In a smaller restaurant, there may be only one printer to generate printed orders for the kitchen staff.

FIG. 26 shows a sample screen display that illustrates how a manager can edit printer settings. The screen display shows that a given printer (located in the “Purple Room”) is associated with a specific type (“Receipt”). Also, the same screen display allows the manager to associate a backup printer with the printer whose settings are being edited. If, for any reason, a check or receipt cannot be printed at the selected printer, it will automatically be printed at the backup printer.

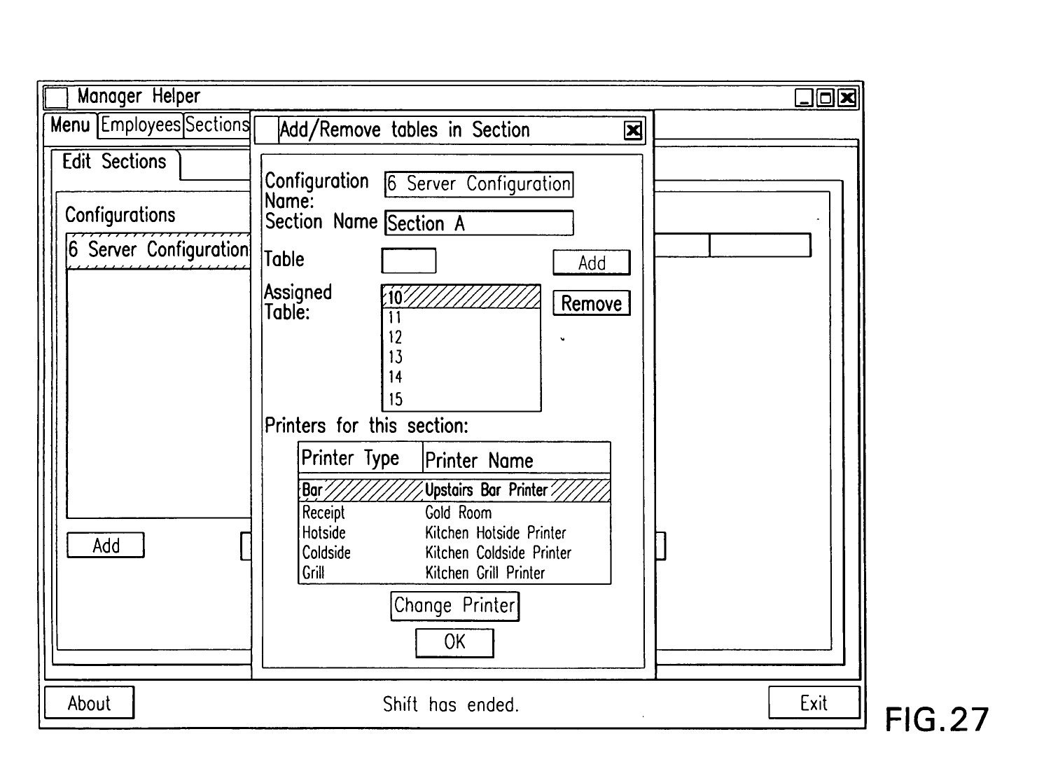

FIG. 27 shows a screen display that illustrates how a manager can assign printers and tables to a particular section. In the example shown, the manager is editing the settings for Section A, and the program allows the manager to define, by indication of table number, the tables forming part of this section. Near the bottom of the display, the manager also has the option of defining the printers for this section.

The actual choice of which printer will generate a check or receipt is made by the waiter or waitress. This choice is normally made through the hand-held units, but can also be made through the stationary touchscreen units (if the waiter is using a stationary touchscreen unit). The software is programmed so that a waiter can select any printer of type “Receipt” for printing of a check or credit card receipt. For example, the waiter might be momentarily at the opposite side of the restaurant, for some reason, and might wish to print a receipt at that location and then bring it to the customer's table.

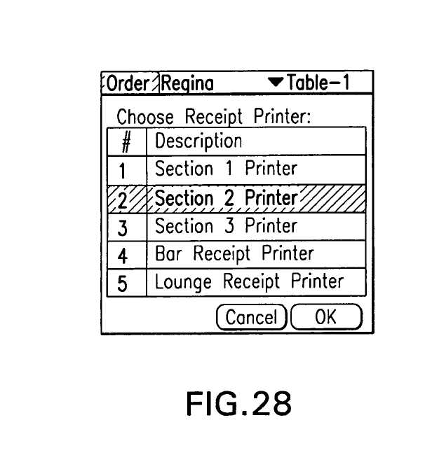

FIG. 28 shows a typical display that appears on one of the hand-held units, by which a waiter chooses a “Receipt” printer for printing a check or credit card receipt. As noted above, the hand-held unit may include its own printer, in which case a waiter can direct the check or receipt to be printed by the unit he is carrying.

Thus, the present invention allows waiters and waitresses to print automatically dining room checks and credit card receipts, at the printer that is closest to the table to which the order belongs. The waiters and waitresses can also send orders directly to printers located closest to the personnel who will fill those orders. Waiters or waitresses have the option of printing checks and receipts at a printer of their choice. If the selected printer does not work, for any reason, the printing job is automatically routed to a default backup printer.

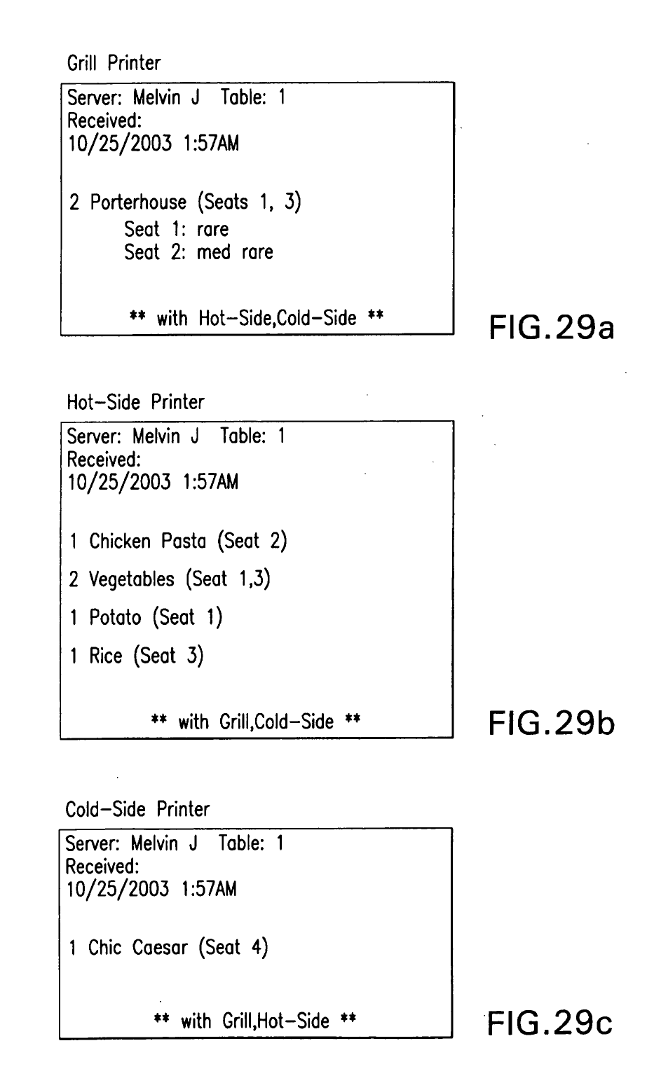

FIGS. 29a-29c illustrate another aspect of the present invention. When a waiter enters an order from a given table, the items ordered may, in general, be directed to different locations in the restaurant. For example, an order for a hot item may be directed to the “hot” section of the kitchen, and an order for a cold item may be directed to the “cold” section. The system is programmed so that appropriate parts of an order for a given table are automatically directed to the appropriate location. In effect, the order is automatically divided into sub-orders. Each sub-order preferably references the table, the waiter, and the time the sub-order was placed. Each sub-order preferably mentions the other sub-orders associated therewith. Thus, when all of the sub-orders are filled, they can be associated with the other sub-orders in the group, and delivered to the table at the same time.

In the example of FIGS. 29a-29c, the table has four seats. The customer in seat 1 has ordered a Porterhouse steak, rare, with a potato and vegetables. The customer in seat 2 has ordered chicken pasta. The customer in seat 3 has ordered a Porterhouse steak, medium rare, with rice and vegetables. The customer in seat 4 has ordered a chicken Caesar salad.

The orders for the Porterhouse steaks are directed to, and printed at, the printer located at the “grill” area of the restaurant, as shown in FIG. 29a. FIG. 29a therefore comprises an example of what would be printed at the “grill printer” location. It is this document that instructs the personnel at the “grill” what to prepare. The orders for the chicken pasta, vegetables, potato, and rice are sent to, and printed at, the printer located at the “hot side” of the kitchen, as shown in FIG. 29b. The order for the salad is directed to the “cold side” of the kitchen, as shown in FIG. 29c. FIGS. 29b and 29c therefore represent the documents that would be printed at the above-indicated locations, instructing the restaurant personnel what to prepare.

Note that each sub-order, printed by each of three different printers, at different locations in the restaurant, includes a reference, at the bottom, to the other two sub-orders. For example, FIG. 29a includes the notation “with Hot-Side, Cold-Side”, indicating that this part of the order should be joined with other parts of the order that are filled at the Hot Side and the Cold Side. Similar notations are printed on the other documents generated at the other printers, as indicated in FIGS. 29b and 29c. Thus, all of the sub-orders can be joined and delivered to the table at the same time.

Note also that the system is programmed to compute the quantities of each item being ordered, so that the printed documents instruct the kitchen personnel exactly what quantities of each item to prepare. Thus, for example, in FIG. 29b, the document requests one chicken pasta, two orders of vegetables, one order for a potato, and one order of rice. The system determines that there are two orders of vegetables from the fact that the waiter has entered vegetables for each of Seats 1 and 3. There are only one each of chicken pasta, potato, and rice, because each of these items was ordered by only one customer at that particular table.

Thus, the system receives raw data, in the form of orders placed by each customer at a table, and entered into the system by the waiter, and converts that data into one or more sets of printed instructions, directed to appropriate departments of the restaurant, to direct the restaurant staff to fill the orders.

The invention can be modified in various ways. The inputs to the hand-held units and/or stationary touchscreen units can be made by keyboard, by stylus, by touchscreen, or by any other means. The stationary touchscreen units can be linked to the server in either a wired or wireless manner. The specific displays and message formats seen by the users can be varied considerably, and the invention is not limited to any particular design of the user interface. The programming can be done in a variety of computer languages, and the components of the invention can use a variety of possible operating systems. The server could be housed in, or could be coextensive with, one of the stationary touchscreen units, or even a hand-held unit, instead of being a separate stand-alone component as shown in FIG. 1. The number of hand-held units and stationary touchscreen units can be varied. The invention could be practiced with as few as one server and one client, which could even be housed in the same machine, or with many client machines as described above. Also, the managerial functions described as being performed on one of the stationary touchscreen units could be programmed to be made from any or all of the hand-held units. For example, the system could be modified such that a hand-held unit could be used to place items on count, or to add or remove items from the menu, either temporarily or permanently, or to perform any or all of the above-described managerial functions. These and other modifications, which will become apparent to those skilled in the art, should be considered within the spirit and scope of the following claims.

1. A system for management of a restaurant or bar, comprising:
a) a server computer, and
b) at least one client computer, the client computer being capable of transmitting information to, and receiving information from, the server computer,
wherein the server is programmed to store and update a menu of items available at the restaurant or bar,
wherein the client computer is programmed to store a local copy of said menu, and to generate orders and to transmit said orders to the server,
wherein the client computer is further programmed to synchronize the local copy of said menu with the menu as stored on the server computer, wherein the local copy of the menu is automatically updated in accordance with changes made in the server.

2. The system of claim 1, wherein at least one of the server computer and the client computer is programmed to store a count representing a quantity of a menu item remaining in stock, and to decrement said count when the menu item is ordered, wherein the client computer is programmed to display said count, and wherein the client computer is programmed not to accept orders for an item whose count has reached zero.

3. The system of claim 1, wherein the client computer includes at least one hand-held unit, wherein the hand-held unit communicates with the server computer by wireless means.

4. The system of claim 1, wherein the client computer includes at least one stationary touchscreen unit, wherein the stationary touchscreen unit communicates with the server computer by wireless means.

5. The system of claim 1, wherein there are a plurality of client computers, wherein some of the client computers comprise hand-held units, and wherein some of the client computers comprise stationary touchscreen units.

6. The system of claim 1, wherein the server is programmed to permit a manager to make permanent additions and deletions to the menu.

7. The system of claim 1, wherein at least one client is programmed to permit a manager to enable and disable a menu item temporarily.

8. The system of claim 1, wherein at least one of the server computer and the client computer is programmed to store a count representing a quantity of a menu item remaining in stock, and to decrement said count when the menu item is ordered, wherein the client computer is programmed to display said count, wherein the client computer is programmed not to accept orders for an item whose count has reached zero,
wherein the server is programmed to permit a manager to make permanent additions and deletions to the menu, and wherein at least one client is programmed to permit a manager to enable and disable a menu item temporarily.

9. The system of claim 8, wherein the client computers are programmed to notify users of any changes made to the menu.

10. The system of claim 1, further comprising a plurality of printers, wherein the client computer comprises means for selecting one of said printers for printing a member of the group consisting of orders, checks, and receipts.

11. The system of claim 1, further comprising a plurality of printers, wherein the client computer includes means for directing portions of an order to at least two distinct printers.

12. A system for management of a restaurant or bar, comprising:
a) a server computer,
b) at least one client computer, the client computer being capable of transmitting information to, and receiving information from, the server computer, and
c) a plurality of printers,
wherein the client computer is programmed to store a copy of a menu of items available at the restaurant and to generate orders and to transmit said orders to the server,
wherein the client computer is programmed to select one of said printers for printing of members of the group consisting of orders, checks, and receipts.

13. A system for management of a restaurant or bar, comprising:
a) a server computer, and
b) at least one client computer, the client computer being capable of transmitting information to, and receiving information from, the server computer,
wherein the server is programmed to store and update a menu of items available at the restaurant or bar,
wherein the client computer is programmed to store a local copy of said menu, and to generate orders and to transmit said orders to the server,
wherein at least one of the server computer and the client computer is programmed to store a count representing a quantity of a menu item remaining in stock, and to decrement said count when the menu item is ordered, wherein the client computer is programmed to display said count, wherein the client computer is programmed not to accept orders for an item whose count has reached zero.

14. A method of managing a restaurant or bar, the method comprising:
a) maintaining a menu of available items in a server computer,
b) storing a local menu of available items in at least one client computer, the client computer being capable of transmitting information to, and receiving information from, the server computer, and
c) updating the local menu stored in the client such that the local menu reflects changes made to the menu stored in the server.

15. The method of claim 14, further comprising:
a) establishing, in at least one of the server computer and the client computer, a count representing a quantity of a menu item remaining in stock,
b) decrementing said count when the menu item is ordered, and
c) displaying said count in the client computer.

16. The method of claim 15, further comprising rejecting orders for a menu item whose count has reached zero.

17. The method of claim 14, wherein the client computer is selected to be at least one hand-held unit which communicates with the server computer by wireless means.

18. The method of claim 14, wherein the client computer is selected to be at least one stationary touchscreen unit which communicates with the server computer by wireless means.

19. The method of claim 14, wherein step (b) includes storing a local menu in a plurality of hand-held units and at least one stationary touchscreen unit, the hand-held and stationary touchscreen units communicating with the server computer by wireless means.

20. The method of claim 14, further wherein step (a) includes the step of periodically making a permanent change to the menu.

21. The method of claim 20, further comprising notifying the client computer of changes to the menu.

22. The method of claim 14, further comprising periodically making a temporary change to the menu by enabling or disabling a menu item through said client computer.

23. The method of claim 22, further comprising notifying the client computer of changes to the menu.

24. A method of managing a restaurant or bar, the method comprising:
a) maintaining a menu of available items in a server computer,
b) storing a local menu of available items in a plurality of client computers, the client computers being capable of transmitting information to, and receiving information from, the server computer, the client computers including a plurality of wireless hand-held units and at least one stationary touchscreen unit,
c) updating the local menu stored in the server such that the local menus in each of the client computers reflect changes made to the menu stored in the server.
d) establishing, in at least one of the server computer and the client computer, a count representing a quantity of a menu item remaining in stock,
e) decrementing said count when the menu item is ordered,
f) displaying said count in the client computer,
g) rejecting orders for a menu item whose count has reached zero.

25. The method of claim 24, further wherein step (a) includes the step of periodically making a permanent change to the menu.

26. The method of claim 24, further comprising periodically making a temporary change to the menu by enabling or disabling a menu item through one of said client computers.

27. A method of managing a restaurant or bar, the method comprising:
a) maintaining a menu of available items in a server computer,
b) storing a menu of available items in at least one client computer, the client computer being capable of transmitting information to, and receiving information from, the server computer, and
c) placing orders for items on the menu, the placing of orders being performed through the client computer, the placing step including choosing a printer which shall print each of said orders, the choosing step being performed through the client computer.

28. The method of claim 27, further comprising generating a printed document reflecting charges to be made to customers of the restaurant or bar, the generating step including the step of choosing a printer which shall print said document.

29. The method of claim 27, wherein the restaurant or bar has at least two distinct printers, and wherein step (c) includes directing different portions of an order to at least two of said distinct printers.

30. A method of managing a restaurant or bar, the method comprising:
a) maintaining a menu of available items in a server computer,
b) storing a menu of available items in at least one client computer, the client computer being capable of transmitting information to, and receiving information from, the server computer,
c) placing orders for items on the menu, the placing of orders being performed through the client computer, and
d) generating a bill to be presented to a customer,
wherein at least one of steps (c) and (d) comprises choosing a printer to print said orders or bills, the choosing step being performed through the client computer.

31. The method of claim 30, wherein the client computer comprises a hand-held unit, and wherein the choosing step comprises choosing a printer positioned at a different location from the hand-held unit.

32. The method of claim 30, wherein the restaurant or bar includes a plurality of distinct printers, and wherein step (c) includes automatically printing different portions of an order on more than one of said distinct printers.
